(19) United States
(12) Patent Application Publication
(10) Pub. No.: US 2003/0018483 A1
(43) Pub. Date: Jan. 23, 2003

(54) System to manage electronic data

(76) Inventors: Clifford A. Pickover, Yorktown Heights, NY (US); William Grey, Millwood, NY (US); Paul A. Moskowitz, Yorktown Heights, NY (US); Stephen J. Boies, Mahopac, NY (US)

Correspondence Address: BUCKLEY, MASCHOFF, TALWALKAR, & ALLISON, 5 ELM STREET, NEW CANAAN, CT, 06840, US

(21) Appl. No.: 09/907,177

(22) Filed: Jul. 17, 2001

(51) Int. Cl. G06F 17/60

(52) U.S. Cl. 705/1

(57) ABSTRACT

A system to manage electronic data operates to store identification information associated with electronic data, the identification information identifying a source associated with the electronic data, to periodically verify the electronic data based on the identification information, to receive an indication that the electronic data will be transferred from a first entity to a second entity, to determine whether to authorize the transfer, to authorize the transfer, and to update the identification information based on the transfer.

### BACKGROUND OF THE INVENTION

1. Field of the Invention

The present invention relates to systems for managing electronic data. More specifically, the present invention concerns a system for periodically verifying and/or for managing the transfer of electronic data.

2. Description of the Related Art

One attractive feature of electronic data is its ability to be easily manipulated. As a result of this ability, most electronic data is readily altered and/or transferred between devices. However, this ability raises concerns for entities that use electronic data. These concerns primarily relate to data integrity and data privacy.

Data integrity is crucial to many companies. For example, merchants rely on collected electronic data to determine customer demographics, customer preferences, market penetration, and other strategic information on which business decisions are based. Some companies exist solely to provide such electronic data to merchants and/or other entities. Accordingly, the success of these latter companies relies on the integrity of the provided data. The integrity of electronic data, however, is continuously jeopardized by the relative ease with which it may be manipulated. The integrity of data is also subject to the reliability of its source. In this regard, a customer may complete a registration form inaccurately, thereby reducing the integrity of electronic data gleaned therefrom.

Data privacy is a chief concern for entities, such as customers, that provide private electronic data. Specifically, customers may be reluctant to provide accurate demographic or preference information to companies for fear that the information will be misused or disseminated without their consent. This fear is exacerbated when the information is provided as electronic data because of the relative ease by which electronic data may be transferred.

In view of the foregoing, what is needed is a system to improve the integrity and to better maintain the privacy of electronic data.

### SUMMARY OF THE INVENTION

In order to address the foregoing needs, the present invention provides a system to manage electronic data in which identification information associated with electronic data is stored, the identification information identifying a source associated with the electronic data, and the electronic data is periodically verified based on the identification information. By periodically verifying the electronic data based on the stored identification information, this aspect of the invention provides an efficient system for improving the integrity of electronic data.

According to a further aspect, an indication is received that the electronic data will be transferred from a first entity to a second entity, it is determined whether to authorize the transfer, and the transfer is authorized. Determining whether to authorize the transfer may include evaluation of a privacy policy associated with the third party and/or reception of permission from the source. This aspect of the invention may thereby serve to protect the privacy of the electronic data.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a topographic view of a network architecture according to embodiments of the present invention.

FIG. 2 is a block diagram of an internal architecture of a data management server according to embodiments to the present invention.

FIG. 3 is a block diagram of an internal architecture of a collection device according to embodiments to the present invention.

FIG. 4 is a representative view of a tabular portion of a data management database according to embodiments of the present invention.

FIG. 5 is a representative view of a tabular portion of a management information database according to embodiments of the present invention.

FIG. 6 is a flow diagram of process steps to manage electronic data according to embodiments of the present invention.

### DETAILED DESCRIPTION

Network Architecture

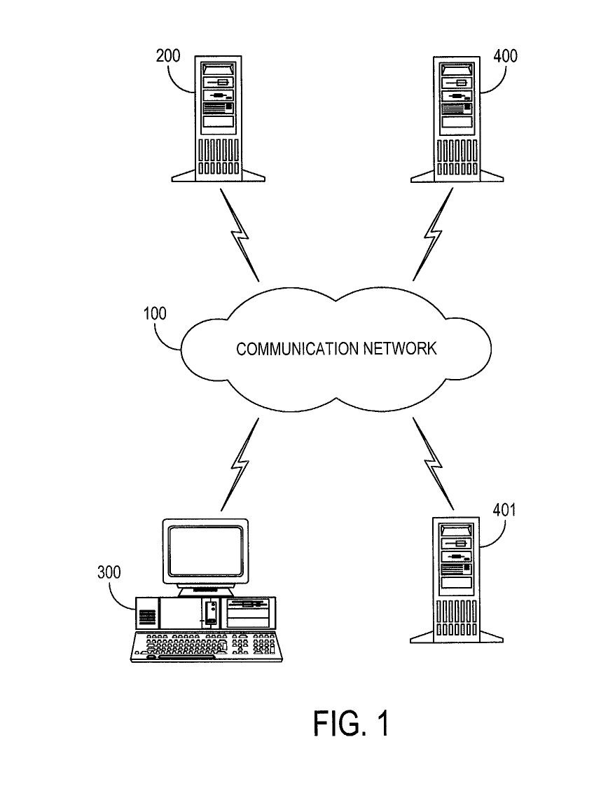

FIG. 1 is a topographic view of a network architecture according to embodiments of the present invention. Of course, network architectures other that that shown in FIG. 1 may be used to implement the invention.

FIG. 1 shows communication network 100 in communication with data management server 200, customer device 300 and collection devices 400 and 401. As such, communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

Data management server 200 may comprise a Web server, local area network server or other device capable of performing steps according to the present invention. According to one embodiment, data management server 200 operates to store identification information associated with electronic data, the identification information identifying a source associated with the electronic data, and to periodically verify the electronic data based on the identification information. By virtue of this operation, data management server 200 improves the integrity of the electronic data.

In other embodiments, data management server 200 operates to store identification information associated with electronic data, the identification information identifying a source associated with the electronic data, to periodically verify the electronic data based on the identification information, to receive an indication that the electronic data will be transferred from a first entity to a second entity, to determine whether to authorize the transfer, to authorize the transfer, and to update the identification information based on the transfer. This operation may be utilized to manage the privacy of the electronic data as well as to improve the integrity of the data.

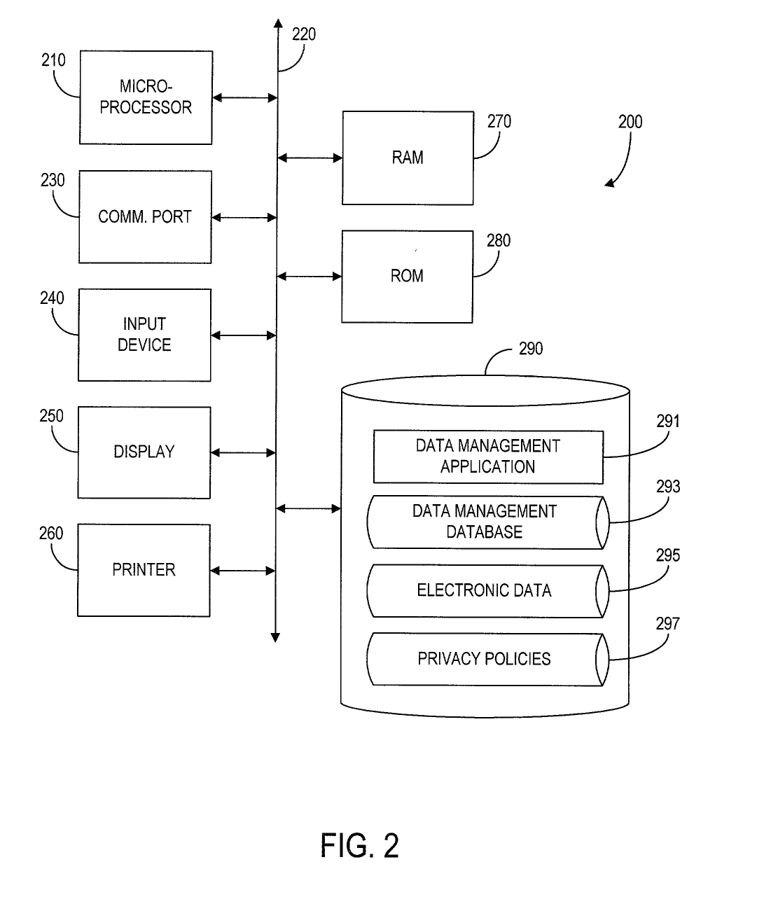

Data management server 200 may also control various operations of an entity providing data management services, such as billing, accounting, sales tracking and the like. It should be noted that data management server 200 may also perform functions unrelated to management services. Physical details of one embodiment of data management server 200 are set forth below with respect to FIG. 2.

Customer device 300 of FIG. 1 comprises a desktop computer. However, customer device 300 may comprise any device or devices for transmitting electronic data over communication network 100, including a Personal Digital Assistant (PDA), a cellular telephone, and a pager. Of course, customer device 300 may also be used to perform other functions, such as word processing, scheduling, e-mail hosting, Web browsing, or the like.

Collection devices 400 and 401 may be operated by any entity that collects electronic data. As mentioned above, such entities include merchants collecting customer registration data and data aggregators whose business is to provide customer information to interested parties. Collection devices 400 and 401 may be used to receive electronic data and identification information associated with the electronic data, and to transmit the identification information to a data management server, in which case the data management server periodically verifies the electronic data based on the identification information. In other embodiments, collection devices 400 and 401 themselves operate to store identification information associated with electronic data, the identification information identifying a source associated with the electronic data, and to periodically verify the electronic data based on the identification information.

According to still other embodiments, collection devices 400 and 401 are used to receive electronic data and identification information associated with the electronic data, to transmit the identification information to a data management server, to transmit an indication to the data management server that the electronic data will be transferred to a second entity, to receive authorization from the data management server to transfer the electronic data, and to transfer the electronic data to the second entity. It should be noted that collection devices 400 and 401 may also be used to perform other functions required by their respective operating entities.

It should also be noted that the elements of FIG. 1 may be connected differently than as shown. For example, some or all of the elements may be connected directly to one another. Of course, embodiments of the invention may include elements that are different from those shown. Moreover, although the illustrated communication links between the components of FIG. 1 appear dedicated, it should be noted that each of the links may be shared by other components. Additionally, elements shown in communication with each other need not be constantly exchanging data. Rather, communication may be established when necessary and severed at other times or always available but rarely used to transmit data.

The following is a brief description of the operation of the FIG. 1 elements according to one particular embodiment of the present invention. Initially, a customer operates a Web browser executing in customer device 300 to purchase an item from a Web site served by collection device 400. In this case, collection device 400 may be operated by a retailer, a company providing online “storefronts”, or another entity. After the transaction, collection device 400 transmits a Web page including a registration form to customer device 300. The Web page includes links to a privacy policy governing electronic data collected by collection device 400. In the present example, the privacy policy specifies that collected electronic data will not be transferred to another entity without approval from the customer from whom the data was collected.

The customer operates customer device 300 to complete the form and transmits the form back to collection device 400, where electronic data is produced from the completed form and associated with information identifying the customer. This identification information may comprise information usable to contact the customer, such as an e-mail or postal address. Next, collection device 400 transmits the electronic data and the identification information to data management server 200. Data management server 200 stores the data and the information and transmits a data identifier to collection device 400. Collection device 400 stores the data identifier to facilitate retrieval of the data and information from data management server 200.

Periodically, data management server 200 verifies the electronic data by contacting the customer using the identification information. The contact may comprise sending an e-mail to the customer asking him to confirm that the electronic data is accurate and to update the electronic data if it is not accurate. The electronic data stored in data management server 200 is then updated based on this verification.

The entity operating collection device 400 may eventually decide to transfer its rights to the electronic data to an entity operating collection device 401. Accordingly, collection device 400 transmits an indication to data management server 200 that the electronic data will be transferred to collection device 401. In response, data management server 200 evaluates the privacy policy associated with the electronic data. Since the privacy policy requires the customer to approve the transfer, the customer is contacted to obtain such approval.

Once approval is obtained, data management server 200 transmits an authorization to collection device 400 to complete the transfer. Accordingly, collection device 400 transmits the electronic data and the data identifier to collection device 401. Data management server 200 then updates its records to reflect that the electronic data is now owned by the entity operating collection device 401.

As mentioned above, the above operation provides an efficient system to improve the integrity of electronic data and to protect the privacy of electronic data. Again, the operation reflects one embodiment of the present invention some alternative arrangements in accordance with the invention are set forth below.

Data management server

FIG. 2 is a block diagram of the internal architecture of data management server 200 according to one embodiment of the invention. As illustrated, data management server 200 includes microprocessor 210 in communication with communication bus 220. Microprocessor 210 may be a Pentium™, RISC™, or other type of processor and is used to execute processor-executable process steps so as to control the components of data management server 200 to provide functionality according to embodiments of the present invention.

Also in communication with communication bus 220 is communication port 230. Communication port 230 is used to transmit data to and to receive data from devices external to data management server 200. Communication port 230 is therefore preferably configured with hardware suitable to physically interface with desired external devices and/or network connections. In one embodiment, electronic data and identification information are received from and transfer authorizations are transmitted to collection devices over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an entity operating data management server 200 to input customer information, billing information, and other information to data management server 200. Of course, such information may also be input to data management server 200 via communication port 230. Commands for controlling operation of data management server 200 may also be input using input device 240, such as commands to verify electronic data, to ensure compliance with a privacy policy, or to transmit an authorization.

Reports may be output to display 250, which may be an integral or separate CRT display, flat-panel display or the like. Display 250 is generally used to output graphics and text to an operator in response to commands issued by microprocessor 210. Printer 260 may also output graphics and text, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, data management application 291 of processor-executable process steps. Microprocessor 210 executes process steps of data management application 291 in order to control data management server 200 to manage electronic data in accordance with the present invention. More specifically, the process steps of data management application 291 may be executed by microprocessor 210 to store identification information associated with electronic data, the identification information identifying a source associated with the electronic data, to periodically verify the electronic data based on the identification information, to receive an indication that the electronic data will be transferred from a first entity to a second entity, to determine whether to authorize the transfer, to authorize the transfer, and to update the identification information based on the transfer.

The process steps of data management application 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

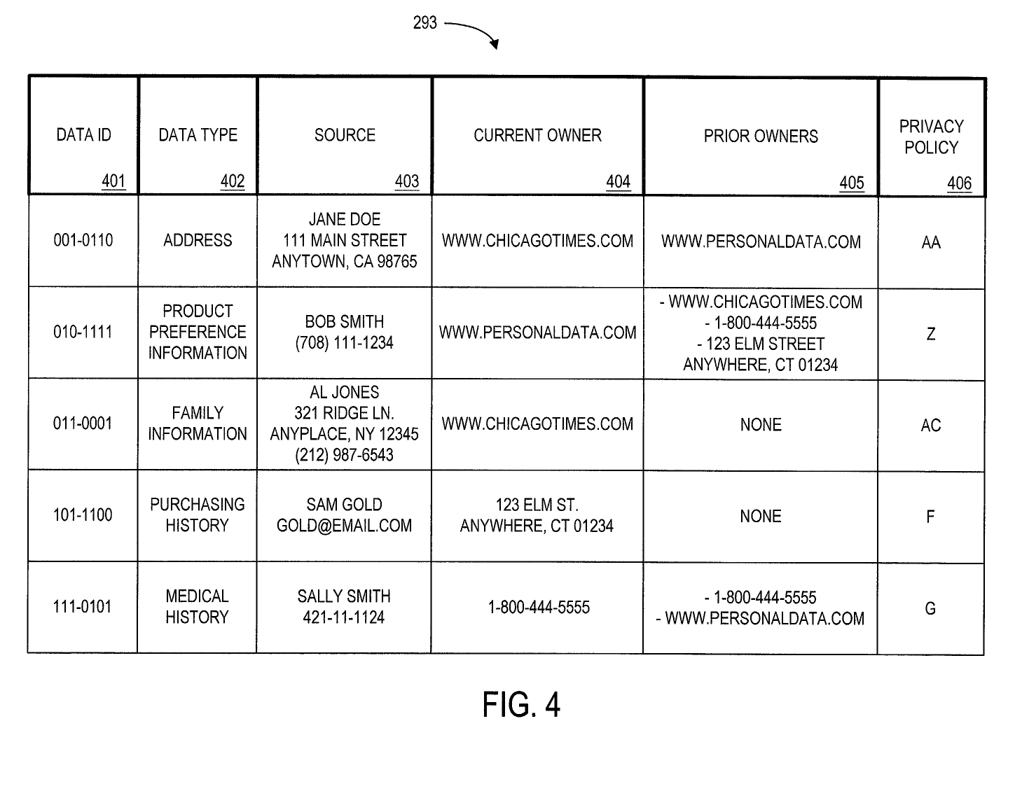

Data storage device 290 also stores data management database 293. Data management database 293 stores information used to manage electronic data according to the present invention. Such information may include a data type, a source, and an owner associated with particular electronic data. One example of data management database 293 is described below with respect to FIG. 4.

Electronic data 295 and associated privacy policies 297 are also stored in data storage device 290. As described above, the stored electronic data may be received from entities collecting the data and the privacy policies are policies applicable to the stored data. Stored electronic data and privacy policies may be associated with one another and with other information in data management database 293 using data identifiers.

Stored in data storage device 290 may also be other unshown elements that may be necessary for operation of data management server 200, such as other applications, other data files, a network server, an operating system, a database management system and “device drivers” for allowing microprocessor 210 to interface with devices in communication with communication port 230. These elements are known to those skilled in the art, and are therefore not described in detail herein.

Collection Device

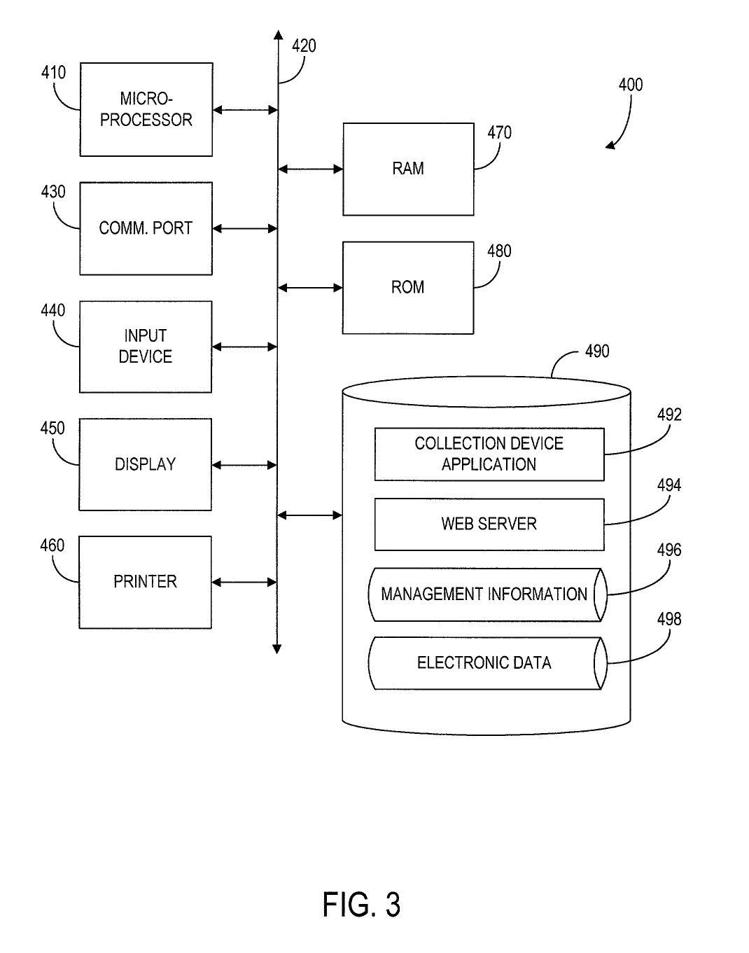

FIG. 3 illustrates several components of collection device 400 according to one embodiment of the invention. The components may comprise any of the specific examples set forth above with respect to identically-named components of data management server 200. Of course, specific functions performed by the components may differ from the functions performed by the identically-named components.

In this regard, communication port 430 may be used to receive electronic data from customers, to transmit copies of the electronic data to data management server 200, and to receive updated electronic information from data management server 200. Input device 440 may be used to input commands to transfer electronic data and/or ownership of electronic data to another collection device, or commands to output a report detailing the status of stored electronic data. Such a report may be output by display 450 or by printer 460. Input device 440, display 450 and printer 460 may also be used in conjunction with other applications provided by collection device 400 which are unrelated to the present invention.

Data storage device 490 stores collection device application 492 of processor-executable process steps. The process steps of collection device application 492 may be executed by microprocessor 410 so as to control collection device 400 to receive electronic data and identification information associated with the electronic data, to transmit the identification information to a data management server, to transmit an indication to the data management server that the electronic data will be transferred to a second entity, to receive authorization from the data management server to transfer the electronic data, and to transfer the electronic data to the second entity. In some embodiments, the process steps of collection device application 492 may be operated to store identification information associated with electronic data, the identification information identifying a source associated with the electronic data, and to periodically verify the electronic data based on the identification information.

The process steps of collection device application 492 may be read from a computer-readable medium, such as a floppy disk, a CD-ROM, a DVD-ROM, a Zip™ disk, a magnetic tape, or a signal encoding the process steps, and then stored in data storage device 490 in a compressed, uncompiled and/or encrypted format. In alternative embodiments, hard-wired circuitry may be used in place of, or in combination with, processor-executable process steps for implementation of the processes of the present invention.

Also stored in data storage device 490 are processor-executable steps of Web server 494. The process steps of Web server 494 may be executed by microprocessor 410 to provide Web pages to Web browsers executing in devices such as customer device 300. The process steps of Web server 494 may also be executed to receive electronic data and identification information from such Web browsers.

Management information 496 is also stored in data storage device 490. Management information 496 may include information associating electronic data with a data management server as well as other data usable to manage electronic data according to the present invention. In this regard, electronic data 498 is also stored in storage device 490.

Data storage device 490 may also store application files, data files and system files other than those shown in FIG. 3. These files may be used to provide various functionality in addition to that provided by the present invention.

Data Management Database

A tabular representation of a portion of data management database 293 is shown in FIG. 4. The information stored in data management database 293 may be entered by an employee through input device 240 of data management server 200, or may be received from collection device 400 over communication network 100. As previously mentioned, the information stored in data management database 293 may be used to manage electronic data according to the present invention.

Data management database 293 includes several records and associated fields. The fields include data ID field 401, data type field 402, source field 403, current owner field 404, prior owners field 405, and privacy policy field 406.

Turning to the specific fields, data ID field 401 of a record represents a set of electronic data stored among electronic data 295 in data storage device 290. Accordingly, data ID field 401 of a record associates particular electronic data with the remaining fields of the record. Data ID 401 may be assigned by data management server 200, by a collection device which collected the represented electronic data, or by another device.

Data type field 402 of a record describes electronic data associated with the record. Such a description may be helpful in classifying the electronic data for reporting, sale, or the like. Source field 403 includes information identifying the source of the associated electronic data. The identification information may include any information, including but not limited to a name, a postal address, a telephone number, an e-mail address, and a social security number. As described above, the identification information of source field 403 may be received from collection device 400 and used to verify associated electronic data.

Current owner field 404 of a record specifies the entity owning the electronic data represented by data ID field 401 of the record. The data of current owner field 404 may be received from the entity from which the associated electronic data was received, or from another entity. An “owner” in this context may be defined according to one or more of several meanings, including an entity possessing a legal right to the electronic data, an entity possessing the data itself, or an entity having collected the data from its source. The owner may be specified in any manner, including by name, Web address, postal address, phone number, etc.

Prior owners field 405 specifies previous owners of the electronic data. Accordingly, an owner is added to prior owners field 405 after associated electronic data is transferred from the owner to another owner. Of course, such a transfer would also cause removal of the owner from current owner field 404.

Privacy policy field 406 of a record includes an identifier identifying a privacy policy stored among privacy policies 297. The identified privacy policy applies to electronic data associated with the record. More specifically, the privacy policy may be used to determine whether to authorize transfer of the electronic data, and/or to ensure that a transfer of the electronic data complies with the privacy policy.

Privacy policies may include any number of limitations on the use or distribution of electronic data. For example, a privacy policy may limit a number of times electronic data may be transferred, define a class of entities that may receive the data, define economic terms under which the data may be transferred, require particular notifications prior to data transfer, set a duration during which the electronic data may be maintained, and set a duration during which the electronic data may be used.

Management Information

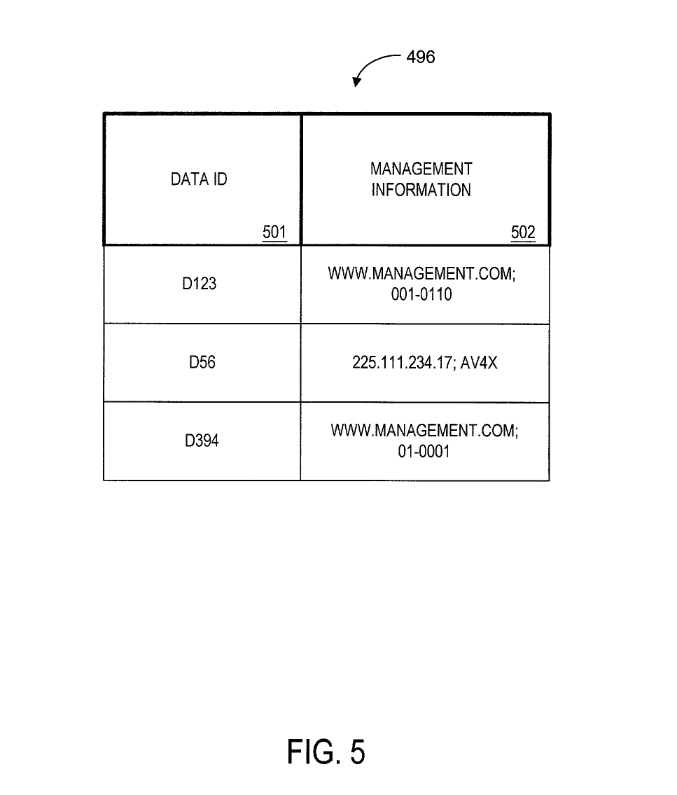

A tabular representation of a portion of management information 496 is shown in FIG. 5. Management information 496 includes information used by collection device 400 to communicate with data management servers such as server 200 so as to manage electronic data according to some embodiments of the present invention.

Data ID field 501 in a record of management information 496 includes an identifier specifying a set of electronic data from electronic data 498. The identifier may be assigned to the electronic data by collection device 400 upon receipt of the electronic data.

Management information field 502 of a record includes information usable to contact a data management server and an identifier representing the electronic data associated with the record. The identifier is an identifier used by the data management server to identify the record. Accordingly, the data of management information field 502 may be used to communicate with a data management server regarding a particular set of electronic data managed by the data management server. In a case that electronic data is not stored by collection device 400, field 502 associated with the electronic data may be used to retrieve the data from an appropriate data management server.

It is contemplated that data management database 293 and management information 496 may include many more records than those shown and that each record may include associated fields other than those illustrated. It should also be noted that the tabular illustrations and accompanying descriptions of data management database 293 and management information 496 merely represent relationships between stored information. A number of other arrangements may be employed besides those suggested.

### SPECIFIC EXAMPLE

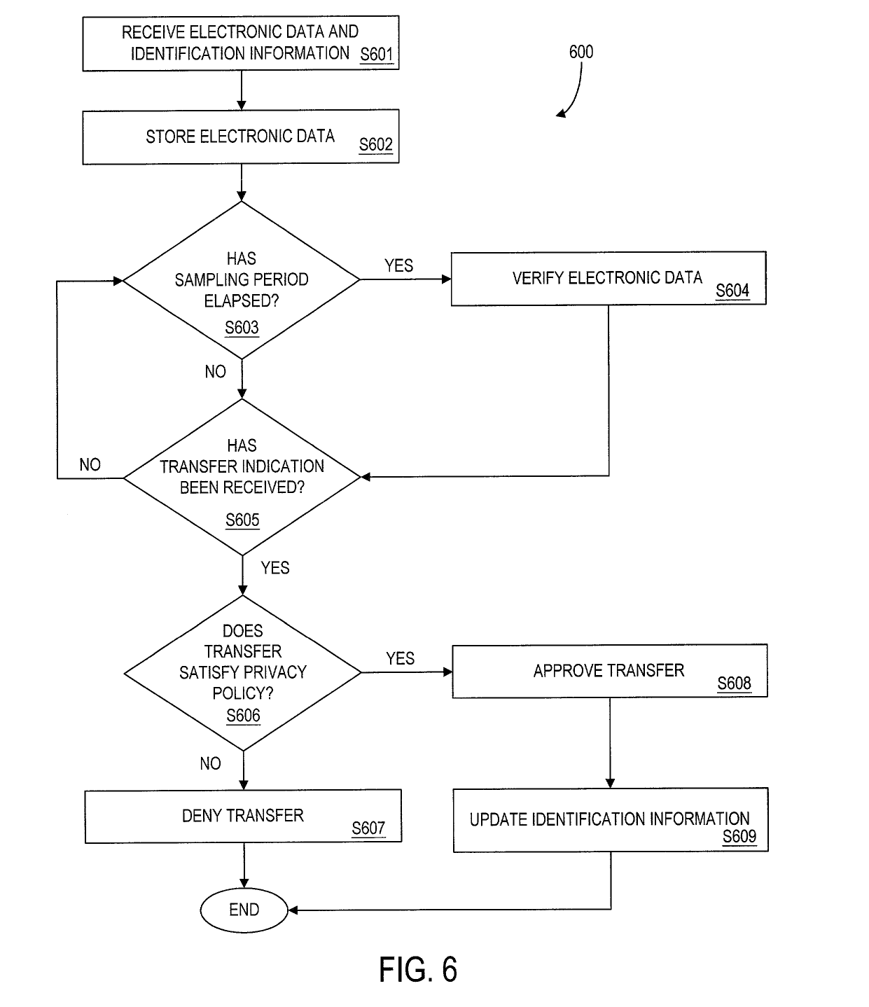

Process steps 600 of FIG. 6 set forth a process to manage electronic data according to an embodiment of the present invention. Process steps 600 are described below as if included in data management application 291 and executed by microprocessor 210 of data management server 200. Of course, it should be noted that process steps 600 may be performed by any device or by any number of devices in combination, including collection device 400. Moreover, some or all of process steps 600 may be performed manually.

Process steps 600 begin at step S601, in which electronic data is received. According to the embodiment described above, the data is received from a customer by way of collection device 400. Specifically, the customer may enter her personal data into a registration form displayed on a Web browser and operate the browser to forward the data from customer device 300 to collection device 400. In accordance with an agreement between the entity operating collection device 400 and data management server 200, the personal data is transmitted as electronic data to data management server 200, where it is received in step S601 along with identification information identifying the customer and the data type.

In some embodiments, collection device 400 stores the electronic data and the identification information. In others, collection device 400 does not store the electronic data and/or the identification information. In some of the latter embodiments, data management server 200 transmits to collection device 400, after step S601, an identifier by which server 200 identifies the electronic data. According to these embodiments, collection device 400 need only store information such as management information 496 in order to access the electronic data and identification information.

Next, the received electronic data and identification information are stored in data storage device 290 in step S602. According to the embodiment illustrated by FIG. 4, the electronic data is stored among electronic data 295 and the identification information is stored in data management database 293 in association with an identifier identifying the electronic data. As described above, the identifier may also be transmitted to collection device 400 in step S602.

In step S603, it is determined whether a sampling period has elapsed. The sampling period may be based on an agreement between the entity operating data management server 200 and collection device 400, on the data type, on the source, or on any other factor. Primarily, it should be noted that the sampling period need not be fixed for each set of electronic data in electronic data 295, nor need it be fixed for a single set of electronic data.

If it is determined in step S603 that the sampling period has elapsed, the electronic data is verified in step S604. Verification may comprise locating a record of data management database 293 associated with the electronic data using data ID field 401, retrieving information from source field 403 of the record, and contacting the source using the retrieved information. Depending on the retrieved information, the contact may comprise sending an e-mail to the customer asking her to confirm that the electronic data is accurate and to update the electronic data if it is not accurate.

Step S604 may proceed in many different manners. For example, the contact may comprise asking the source whether the electronic data is accurate, without asking for correction of inaccurate data. In other examples, the source may be asked for proof of existing or corrected electronic data, may seek third-party resources to confirm or update electronic data, or may threaten to void a source's registration with collection device 400 unless the source responds to the contact.

Flow continues to step S605 after step S604 or in a case that the determination in step S603 is negative. In step S605, it is determined whether an indication that the electronic data will be transferred from collection device 400 to another entity has been received. The transfer may comprise transferring ownership, revealing the electronic data to the other entity, or the like. If it is determined that an indication has not been received, flow returns to step S603.

If the determination is affirmative, flow proceeds to step S606. According to step S606, data management server 200 determines if the transfer satisfies a privacy policy associated with the electronic data. First, the associated privacy policy is located from among privacy policies 297 using privacy policy field 406 associated with the electronic data. The located privacy policy is analyzed to determine whether the transfer would satisfy the policy. In some cases, affirmative steps must be taken in step S606 to ensure compliance with the policy. For example, in a case that the privacy policy requires approval from the source prior to any transfer, data management server 200 contacts the source in step S606 to obtain such approval.

If the transfer would not comply with the privacy policy, the transfer is denied in step S607. Denial may comprise a lack of a response to the indication received in step S605, or a transmission to collection device 400 indicating that the transfer is not authorized. Flow terminates after step S607.

If it is determined that the transfer satisfies the privacy policy, data management server 200 transmits an authorization to collection device 400 in step S608. In some embodiments, also transmitted in step S608 is an indication to the other entity that the electronic data is accurate. The indication may also indicate a time at which the electronic data was last verified, results of the last verification, or other relevant information. The indication may further include a certification that the electronic data will be transferred in accordance with a privacy policy that was in effect at the time the electronic data was collected.

The identification information stored in data management database 293 in association with the electronic data is updated in step S609. In the present example, information in associated current owner field 404 is updated to reflect the other entity and to no longer reflect collection device 400, and associated prior owners field 405 is updated to reflect collection device 400. Process steps 600 then terminate.

As a result of the foregoing process, an updated record of identification information may be maintained for the collected electronic data. In addition, the integrity of the electronic data may be efficiently controlled, the privacy of the electronic data may be efficiently maintained, and an entity to whom the electronic information is transferred may be better insulated from legal liabilities, regulatory issues, and negative publicity.

It should be noted that many of process steps 600 may be performed by the device which collects the data from a customer, or collection device 400 in the previous example. In such a case, collection device 400 may store information such as that found in data management database 293 and privacy policies 297. In addition, process steps may be performed by data management server 200 using identification information and/or privacy policies stored in collection device 400. In the latter case, the entity operating collection device 400 may subscribe to a “data management service” provided by data management server 200.

According to other embodiments, data management server 200 may issue periodic reports regarding whether subscribing entities are complying with certain privacy policies or standards of privacy. In addition, data management server 200 may provide, by request, copies of electronic data and associated identification information to customers from which the electronic data was obtained. Moreover, updates to identification information may be disseminated to all current owners of an associated set of electronic data, thereby enabling the owners to maintain the identification information as well.

As mentioned above, process steps 600 may be employed in many types of applications. For example, data management server 200 may be operated by a credit institution and may therefore store electronic data relating to the credit history of various borrowers. The electronic data could be managed according to process steps 600 and provided to lendors along with an indication that the data has been thusly managed.

Although the present invention has been described with respect to particular embodiments thereof, those skilled in the art will note that various substitutions may be made to those embodiments described herein without departing from the spirit and scope of the present invention.

What is claimed is:

1. A method comprising:
storing identification information associated with electronic data, the identification information identifying a source associated with the electronic data; and
periodically verifying the electronic data based on the identification information.

2. A method according to claim 1, wherein the verifying step comprises:
transmitting an inquiry to the source.

3. A method according to claim 2, wherein the inquiry asks the source to verify accuracy of a portion of the electronic data.

4. A method according to claim 3, further comprising:
receiving a response to the inquiry; and
transmitting the response to the third party.

5. A method according to claim 3, wherein the inquiry asks the source to correct inaccurate portions of the electronic data.

6. A method according to claim 1, wherein the verifying step comprises:
receiving information from a third party.

7. A method according to claim 1, further comprising:
receiving an indication that the electronic data will be transferred from a first entity to a second entity; and
updating the identification information based on the indication.

8. A method according to claim 7, further comprising:
determining whether to authorize the transfer; and
authorizing the transfer.

9. A method according to claim 8, wherein the determining step comprises:
evaluating a privacy policy associated with the third party.

10. A method according to claim 9, wherein the determining step further comprises:
receiving permission from the source.

11. A method according to claim 9, further comprising:
transmitting a second indication to the second entity, the second indication verifying the electronic data.

12. A method according to claim 9, wherein the updated identification information identifies all past transfers of the electronic data.

13. A method according to claim 1, wherein the electronic data comprises credit history information and the identification information identifies a borrower.

14. A method according to claim 1, wherein the electronic data comprises demographic information and the identification information identifies a consumer.

15. A method comprising:
storing identification information associated with remotely-stored electronic data, the identification information identifying a source associated with the electronic data; and
periodically verifying the electronic data based on the identification information.

16. A method according to claim 15, wherein the electronic data is not locally stored.

17. A method according to claim 15, further comprising:
receiving an indication that the electronic data will be transferred from a first entity to a second entity; and
updating the identification information based on the indication.

18. A method according to claim 17, further comprising:
determining whether to authorize the transfer; and
authorizing the transfer.

19. A method according to claim 18, wherein the determining step comprises:
evaluating a privacy policy associated with the third party.

20. A method according to claim 19, wherein the determining step further comprises:
receiving permission from the source.

21. A method according to claim 17, further comprising:
transmitting a second indication to the second entity, the second indication verifying the electronic data.

22. A method according to claim 17, wherein the updated identification information identifies all past transfers of the electronic data.

23. A method according to claim 15, wherein the electronic data comprises credit history information and the identification information identifies a borrower.

24. A method according to claim 15, wherein the electronic data comprises demographic information and the identification information identifies a consumer.

25. A method comprising:
receiving electronic data and identification information associated with the electronic data; and
transmitting the identification information to a data management server,
wherein the data management server periodically verifies the electronic data based on the identification information.

26. A method according to claim 25, further comprising:
transmitting the electronic information to the data management server.

27. A method according to claim 25, further comprising:
transmitting an indication that the electronic data will be transferred to a second entity.

28. A method according to claim 27, further comprising:
receiving an authorization to transfer the electronic data to the second entity.

29. A method comprising:
storing identification information associated with electronic data, the identification information identifying a source associated with the electronic data;
periodically verifying the electronic data based on the identification information;
receiving an indication that the electronic data will be transferred from a first entity to a second entity;
determining whether to authorize the transfer;
authorizing the transfer; and
updating the identification information based on the transfer.

30. A method according to claim 29, further comprising:
transmitting an indication to the second entity indicating that the electronic data is accurate.

31. A method according to claim 29, further comprising:
transmitting an indication to the second entity indicating that the electronic data has been recently verified.

32. A method according to claim 29, further comprising:
transmitting a certification to the second entity certifying that the transfer will be in accordance with a privacy policy in effect at the time the electronic data was collected.

33. A method according to claim 29, wherein the electronic data comprises credit history information and the identification information identifies a borrower.

34. A method according to claim 29, wherein the electronic data comprises demographic information and the identification information identifies a consumer.

35. A method comprising:
receiving electronic data and identification information associated with the electronic data;
transmitting the identification information to a data management server;
transmitting an indication to the data management server that the electronic data will be transferred to a second entity;
receiving authorization from the data management server to transfer the electronic data; and
transferring the electronic data to the second entity.

36. A system to verify electronic information, comprising:
a device, comprising:
a first processor; and
a first storage device in communication with the first processor and storing instructions adapted to be executed by the first processor to:
receive electronic data; and
transmit identification information identifying a source associated with the electronic data; and
a data management server, comprising:
a second processor; and
a second storage device in communication with the second processor and storing instructions adapted to be executed by the second processor to:
receive the identification information; and
periodically verify the electronic data based on the identification information.

37. A medium storing processor-executable process steps, the process steps comprising:
a step to store identification information associated with electronic data, the identification information identifying a source associated with the electronic data; and
a step to periodically verify the electronic data based on the identification information.

38. A medium according to claim 37, wherein the verifying step comprises:
a step to transmit an inquiry to the source.

39. A medium according to claim 38, wherein the inquiry asks the source to verify accuracy of a portion of the electronic data.

40. A medium according to claim 39, the process steps further comprising:
a step to receive a response to the inquiry; and
a step to transmit the response to the third party.

41. A medium according to claim 39, wherein the inquiry asks the source to correct inaccurate portions of the electronic data.

42. A medium according to claim 37, wherein the verifying step comprises:
a step to receive information from a third party.

43. A medium according to claim 37, the process steps further comprising:
a step to receive an indication that the electronic data will be transferred from a first entity to a second entity; and
a step to update the identification information based on the indication.

44. A medium according to claim 43, the process steps further comprising:
a step to determine whether to authorize the transfer; and
a step to authorize the transfer.

45. A medium according to claim 44, wherein the determining step comprises:
a step to evaluate a privacy policy associated with the third party.

46. A medium according to claim 45, wherein the determining step further comprises:
a step to receive permission from the source.

47. A medium according to claim 43, the process steps further comprising:
a step to transmit a second indication to the second entity, the second indication verifying the electronic data.

48. A medium according to claim 43, wherein the updated identification information identifies all past transfers of the electronic data.

49. A medium according to claim 37, wherein the electronic data comprises credit history information and the identification information identifies a borrower.

50. A medium according to claim 37, wherein the electronic data comprises demographic information and the identification information identifies a consumer.

51. A medium storing processor-executable process steps, the process steps comprising:
a step to store identification information associated with remotely-stored electronic data, the identification information identifying a source associated with the electronic data; and
a step to periodically verify the electronic data based on the identification information.

52. A medium according to claim 51, wherein the electronic data is not locally stored.

53. A medium according to claim 51, the process steps further comprising:
a step to receive an indication that the electronic data will be transferred from a first entity to a second entity; and
a step to update the identification information based on the indication.

54. A medium according to claim 53, the process steps further comprising:
a step to determine whether to authorize the transfer; and
a step to authorize the transfer.

55. A medium according to claim 54, wherein the determining step comprises:
a step to evaluate a privacy policy associated with the third party.

56. A medium according to claim 55, wherein the determining step further comprises:
a step to receive permission from the source.

57. A medium according to claim 53, the process steps further comprising:
a step to transmit a second indication to the second entity, the second indication verifying the electronic data.

58. A medium according to claim 53, wherein the updated identification information identifies all past transfers of the electronic data.

59. A medium according to claim 51, wherein the electronic data comprises credit history information and the identification information identifies a borrower.

60. A medium according to claim 51, wherein the electronic data comprises demographic information and the identification information identifies a consumer.

61. A medium storing processor-executable process steps, the process steps comprising:
a step to receive electronic data and identification information associated with the electronic data; and
a step to transmit the identification information to a data management server,
wherein the data management server periodically verifies the electronic data based on the identification information.

62. A medium according to claim 61, the process steps further comprising:
a step to transmit the electronic information to the data management server.

63. A medium according to claim 61, the process steps further comprising:
a step to transmit an indication that the electronic data will be transferred to a second entity.

64. A medium according to claim 63, the process steps further comprising:
a step to receive an authorization to transfer the electronic data to the second entity.

65. A medium storing processor-executable process steps, the process steps comprising:
a step to store identification information associated with electronic data, the identification information identifying a source associated with the electronic data;
a step to periodically verify the electronic data based on the identification information;
a step to receive an indication that the electronic data will be transferred from a first entity to a second entity;
a step to determine whether to authorize the transfer;
a step to authorize the transfer; and
a step to update the identification information based on the transfer.

66. A medium according to claim 65, the process steps further comprising:
a step to transmit an indication to the second entity indicating that the electronic data is accurate.

67. A medium according to claim 65, the process steps further comprising:
a step to transmit an indication to the second entity indicating that the electronic data has been recently verified.

68. A medium according to claim 65, the process steps further comprising:
a step to transmit a certification to the second entity certifying that the transfer will be in accordance with a privacy policy in effect at the time the electronic data was collected.

69. A medium according to claim 65, wherein the electronic data comprises credit history information and the identification information identifies a borrower.

70. A medium according to claim 65, wherein the electronic data comprises demographic information and the identification information identifies a consumer.

71. A medium storing processor-executable process steps, the process steps comprising:
a step to receive electronic data and identification information associated with the electronic data;
a step to transmit the identification information to a data management server;
a step to transmit an indication to the data management server that the electronic data will be transferred to a second entity;
a step to receive authorization from the data management server to transfer the electronic data; and
a step to transfer the electronic data to the second entity.

72. An apparatus comprising:
a processor; and
a storage device in communication with the processor and storing instructions adapted to be executed by the processor to:
store identification information associated with electronic data, the identification information identifying a source associated with the electronic data; and
periodically verify the electronic data based on the identification information.

73. An apparatus comprising:
a processor; and
a storage device in communication with the processor and storing instructions adapted to be executed by the processor to:
store identification information associated with remotely-stored electronic data, the identification information identifying a source associated with the electronic data; and
periodically verify the electronic data based on the identification information.

74. An apparatus comprising:
a processor; and
a storage device in communication with the processor and storing instructions adapted to be executed by the processor to:
receive electronic data and identification information associated with the electronic data; and
transmit the identification information to a data management server,
wherein the data management server periodically verifies the electronic data based on the identification information.

75. An apparatus comprising:
a processor; and
a storage device in communication with the processor and storing instructions adapted to be executed by the processor to:
store identification information associated with electronic data, the identification information identifying a source associated with the electronic data;
periodically verify the electronic data based on the identification information;
receive an indication that the electronic data will be transferred from a first entity to a second entity;
determine whether to authorize the transfer;
authorize the transfer; and
update the identification information based on the transfer.

76. An apparatus comprising:
a processor; and
a storage device in communication with the processor and storing instructions adapted to be executed by the processor to:
receive electronic data and identification information associated with the electronic data;
transmit the identification information to a data management server;
transmit an indication to the data management server that the electronic data will be transferred to a second entity;
receive authorization from the data management server to transfer the electronic data; and
transfer the electronic data to the second entity.
